(19) United States
(12) Patent Application Publication
(10) Pub. No.: US 2025/0346001 A1
(43) Pub. Date: Nov. 13, 2025

(54) Automatic joining machine and contact heating device for thermally induced, seam bonding of flat, flexible material layers

(71) Applicant: Leister Technologies AG, Kägiswil (CH)

(72) Inventors: Stefan Gasser, Sachseln (CH); Rafael Fanger, Stalden (CH); Pascal Küng, Kriens (CH); Peter Christen, Kriens (CH)

(21) Appl. No.: 19/090,824

(22) Filed: Mar. 26, 2025

(30) Foreign Application Priority Data
Mar. 27, 2024 (EP) 24 166 634.6

(51) Int. Cl. B29C 65/20; B29C 65/30

(52) U.S. Cl. CPC B29C 65/20; B29C 65/30

(57) ABSTRACT

A contact heating device for thermally induced (materially cohesive) seam bonding of weldable and/or gluable flat flexible material layers with each other, which are configured as a material web, a material band and/or a material piece and are arranged at least partially overlapping, is provided, the contact heating device comprising: a first terminal electrode and a second terminal electrode; and a heating element connected between the terminal electrodes; wherein the heating element is configured as a directly energized, flat, planar sheet steel blank. The present invention further relates to an automatic welding or joining machine, a hand-held device and a method.

### CROSS-REFERENCE TO RELATED APPLICATIONS

This application claims the priority of European patent application No. 24 166 634.6, filed Mar. 27, 2024, which is incorporated herein by reference in its entirety.

### TECHNICAL FIELD

The present invention relates to a contact heating device for the thermally induced seam bonding of weldable and/or gluable flat flexible material layers with each other, which are configured as a material web, a material band and/or a material piece and are arranged at least partially overlapping. The present invention also relates to automatic joining machines and a hand-held device for the thermally induced seam bonding of weldable and/or gluable flat flexible material layers with each other.

### BACKGROUND

Systems and automatic joining machines for thermally induced seam bonding of weldable and/or gluable flat flexible material layers are generally known from the prior art. For example, the Swiss company and present applicant “Leister Technologies AG” develops and manufactures automatic joining machines and welding apparatuses that are used in particular for joining thermoplastic membranes on roofs, landfills, tunnels, truck tarpaulins and shading systems. Heat can be applied by means of hot air or a heating wedge.

Electrical heating elements are known as such and are also used, for example, in welding equipment for overlap welding of plastic webs, in which the webs are heated, plasticized or melted at their joining surfaces by a heating wedge and then joined together under pressure in a materially bonded manner by pressure rollers. Thereby, the heating wedge is guided between the webs when the film webs are in contact. Commonly used heating wedges are manufactured as a three-dimensional wedge-shaped block, typically made of metal due to its good heat-conducting properties, and are heated by a heating cartridge, which is inserted into the wedge-shaped body of the heating wedge, to a temperature above the melting temperature of the plastic material web or above the melting temperature of an adhesive applied to it.

EP 2 005 795 B1 discloses an electrical heating element, in particular for a hot-wedge film welding device, having two electrodes and a heating resistor arranged between the electrodes, such that an application of an electrical voltage to the electrodes results in heat being produced along the length of the heating resistor, wherein the heating resistor is made from a corrosion-resistant material and having a top side and a bottom side opposite the top side, with both sides of the heating resistor converging at an acute angle, wherein the heating resistor is produced by using an electrically conductive ceramic material.

The heating resistor according to EP 2 005 795 B1 is formed corresponding to the shape of a three-dimensional heating wedge of a film welding device, so that it can replace the heating cartridge and the heating wedge of a conventional film welding device.

EP 3 269 534 B1 discloses an automatic joining machine or automatic bonding apparatus and a method for thermally induced materially cohesive seam bonding of weldable and/or gluable flat flexible material layers with each other, which are configured as a material web, a material band and/or a material piece and arranged at least partially overlapping by an electrically controlled contact heating arrangement through a heating wedge welding method. The temperature and/or the power of the heating wedge, which is formed by a three-dimensionally wedge-shaped folded sheet steel blank, is controlled as a function of the relative velocity between the material layers and the automatic bonding apparatus. This is performed so that the thermal energy that is transferred by the heating wedge to the material layers to be glued is kept constant. For this purpose, the relative velocity is detected and the power of the heating wedge is automatically adjusted when the relative velocity changes.

### SUMMARY

Against this background, it is an object of the present disclosure to provide an improved contact heating device, an improved automatic joining machine and/or an improved hand-held device for thermally induced seam (material or materially bonded or materially cohesive) bonding of weldable and/or gluable (adhesive) flat flexible material layers to one another, which are configured as a material web, material strip and/or material piece and arranged to at least partially overlap one another. In particular, it would be desirable to improve handling and to make handling easier even for less experienced users. It would also be desirable to further improve operational safety. Furthermore, it would be desirable to improve efficiency and/or a welding speed.

According to a first aspect of the present disclosure, a contact heating device is provided for thermally induced seam bonding of weldable and/or gluable flat flexible material layers with each other, which are configured as a material web, a material band (a material strip) and/or a material piece and are arranged at least partially overlapping, wherein the heating element is configured as a directly energized, flat, planar sheet steel blank. In other words, the heating element is configured as a flat planar metal sheet through which current is passed directly for heating. The heating element can consist of a directly energized, flat and planar sheet steel blank.

According to a further aspect of the present disclosure, there is proposed an automatic joining machine for thermally induced, seam bonding of flat, flexible material layers with a contact heating device as described in the context of the present disclosure. In the context of the present disclosure, an automatic joining machine is also referred to as an automatic welding machine. The automatic machine can thereby be configured as a movable device that moves along the joining area. However, the automatic machine can also be configured as a stationary device in which the joining region moves relative to the device.

According to a further aspect of the present disclosure, a hand-held device, in particular a battery-powered hand-held device, for thermally induced, seam bonding of flat, flexible material layers is provided comprising a contact heating device as described in the context of the present disclosure.

According to a further aspect of the present disclosure, a method for thermally induced seam bonding of flat, flexible material layers with a contact heating device as described in the context of the present disclosure is provided.

According to a further aspect of the present disclosure, the use of a contact heating device for thermally induced seam bonding of weldable and/or gluable flat flexible material layers with each other, which are configured as a material web, a material band and/or a material piece and are arranged at least partially overlapping, is provided, wherein the contact heating device comprises the following: a first terminal electrode and a second terminal electrode; and a heating element connected between the terminal electrodes; wherein the heating element is configured as a directly energized, flat, planar sheet steel blank.

The inventors have recognized that in the prior art in the field of contact heating devices for thermally induced seam bonding of weldable and/or gluable flat flexible material layers with each other, which are configured as a material web, a material band and/or a material piece and arranged at least partially overlapping, wedge-shaped heating wedges are inserted, i.e. 3D solid bodies, in particular with inserted heating cartridges or folded wedge-shaped structures. Such a wedge-shaped structure according to the prior art provides a high mechanical stability.

However, in the solution according to an aspect of the present invention, a different approach is suggested, wherein the heating element connected between the terminal electrodes consists of a directly energized, flat, planar sheet steel blank. Thus, instead of providing a contact heating device with the highest possible mechanical stability in the form of a wedge, the heating element is configured as a directly energized, flat, planar sheet steel blank. The use of a flat sheet steel leads to a high level of mechanical flexibility of the heating element, which has a positive effect on the thermal contact between the heating element and the welding material, which is essential for good welding quality. The heating element can thus be configured as a flexible heating element and can be configured to adapt to a variable contour between the material layers. An advantage of the proposed solution can be that thermal contact is improved in a simple and cost-effective way. In contrast thereto a thermal contact in conventional heating wedges is forced by the steepness of the upper and lower surfaces of the wedge. This can also require more force with conventional heating wedges when advancing the heating wedge between the material layers.

A further advantage of the proposed solution can be that in addition to compensating an uneven surface the flexibility of the heating element made of a flat planar sheet steel blank can compensate for slight misalignments or mis-manipulations. In other words, such a contact heating device can be fault-tolerant with regard to a not completely correctly aligned attachment of the contact heating device or the heating element. An advantage can be that handling can be facilitated, in particular for less experienced users.

A further advantage of the proposed solution can be that the operating costs can be reduced. Depending on the material of the material layers to be welded or glued, the heating element can be exposed to corrosion or contaminations that are difficult to remove. An advantage of the proposed solution can be that the heating element can be manufactured from a directly energized, flat, planar sheet steel blank at low cost and can be replaced inexpensively as a replacement part. A further advantage can be that a more sustainable solution can be provided thanks to the low material usage.

A further advantage of the proposed solution can be that the operational safety can be improved since the heating element only has a low thermal mass. A further advantage can be that the heating element made from a directly energized, flat, planar sheet steel blank can provide a high level of efficiency, in particular a low power loss during heat up and operation. A further advantage can be that fast temperature control and/or high welding speeds can be enabled.

A further advantage of the proposed solution can be that a uniform heating to an upper material layer on a top side of the heating element and to a lower material layer on a bottom side of the heating element can be provided. Since the heating element consists of a directly energized, flat, planar sheet steel blank, there is no or no significant temperature difference between the top and bottom sides of the sheet steel blank. An advantage can be that the seam or joint quality can be improved.

During operation, the first terminal electrode and the second terminal electrode can be connected to a preferably controllable current and/or voltage source. The heating element is coupled between the first and second terminal electrodes. The electrical power is thereby converted directly into thermal power in the sheet steel blank. The sheet steel blank thus serves directly as a heating conductor.

In the context of the present disclosure, a flat, planar sheet steel blank can refer to a planar sheet metal element, in particular an unbent sheet metal element. In the context of the present disclosure a planar or unbent sheet metal element in addition to a complete flat sheet metal element can also refer to a sheet metal element having only a slight curvature, for example having a curvature of no more than 20°, in particular of no more than 10°, in particular of no more than 5°, with respect with respect to a plane of the steel sheet metal. In particular, the planar sheet metal element can consist of a single-layer sheet steel blank. In particular, the planar sheet steel blank is non-folded and is not configured in a wedge shape. However, a non-folded area of the sheet steel blank, which is understood to be the heating element, can also be adjoined by further areas that form the terminal electrodes or parts thereof. The heating element can be considered to be that part of the sheet steel blank which is configured to provide at least 70%, in particular at least 80%, in particular at least 90% of the heating power of the contact heating device. Advantageously, the sheet steel blank of the heating element is as thin as possible, as mechanically flexible as possible and configured to provide the most uniform thermal contact possible.

The sheet steel blank of the heating element can comprise at least one partial cut in longitudinal direction. In particular, the sheet steel blank of the heating element can comprise a planar U-shaped geometry. In this case, a first leg of the sheet steel blank of the heating element can be connected to the first terminal contact on a first side of the partial cut and a second leg of the sheet steel blank of the heating element can be connected to the second terminal contact on a second side of the partial cut.

The sheet steel blank of the heating element, or forming the heating element, can comprise: a first flat, planar leg, which is connected to the first terminal electrode; a second flat, planar leg, which is connected to the second terminal electrode; wherein the first leg and the second leg are arranged flat on top of each other or adjacent to each other in the same plane; and wherein the sheet steel blank of the heating element comprises a connection region at a heating element tip, which connects the first leg and the second leg to one another. In particular, the first leg, the second leg and the connection region or area can lie in the same plane. The first and second legs can be configured to extend longitudinally in a direction along a feed direction of the contact heating device between the material layers. The connection region at the tip of the heating element can extend transversely to the legs and transversely to the feed direction.

In a further refinement, the heating element can be configured to provide an increased temperature in the connection region compared to the legs. An advantage of this solution can be that a heat distribution can be provided that is advantageous for the welding or gluing application. In particular, the connection region can in the feed direction be arranged towards the back so that the material layers to be joined are exposed to an increased temperature immediately before they come into contact with each other after the contact heating device. This can improve handling, as the material layers are not unnecessarily early brought to too high temperatures and may adhere to the contact heating device prematurely in a melted or fused state, for example during work breaks or during initial positioning or repositioning. The inventors have recognized that, in contrast to conventional voluminous heating wedges with a high thermal mass, with the proposed solution it is possible to flexibly provide advantageous and locally varying heat distributions over a surface of the sheet steel blank of the heating element.

The heating element can be configured to provide uniform heat distribution at an in particular rear edge, for example in a connection region at a heating element tip of the heating element. For example, the heating element can configured to provide a uniform heat distribution over a width of the heating element, at least in a connection region or at the heating element tip. As used herein, uniform heat distribution can be understood here to mean that the temperature or the heat emitted during operation varies by no more than 40%, in particular by no more than 25%, in particular by no more than 15%.

The connection region can comprise structurings (or structures) in the form of incisions (or recesses or openings) which are configured to locally reduce the energized cross-section (cross-section supplied with electrical current) in comparison to an unstructured cross-section, and thus to locally increase the heating power. In particular, the sheet steel blank of the heating element can have a U-shaped geometry with structurings in the connection region and adjacent thereto. In other words, the sheet steel blank of the heating element can have a U-shaped geometry and have structurings in the area of the redirection in the form of incisions, which reduce the cross-section with current flow locally in comparison to the unstructured cross-section, and thus increase the heating power locally. In the context of the present disclosure, an incision can also refer to a recess or opening. Thereby, the incision does not necessarily have to penetrate the sheet steel blank completely, but can also include a recess in the sheet steel blank. Also a recess can influence the cross-section and cause a concentration of current and thus altered heating behavior. The incisions can, for example, be formed as punched or laser-cut incisions in the sheet steel blank. An advantage of this solution can be its cost-efficient manufacturing.

In a further refinement, the incisions can be configured as elongated incisions, in particular as elongated incisions, at an angle to the rear edge of the heating element tip, in particular at an angle between 20° and 80°, in particular between 30° and 60°. Thanks to the elongated incisions, the current distribution can be altered advantageously. An advantage of this solution can be an advantageous heat distribution.

The incisions can be arranged symmetrically, at least in sections. In particular, the incisions can be arranged in a fanned-out tree shape. A tree-shaped structure of incisions can comprise branches. An advantage of this solution can be an improved heat distribution, in particular a more even heat distribution, which can be provided by the sheet steel blank of the heating element.

The incisions can comprise several parallel slots of different lengths. A advantage of this solution can be that it is easy to manufacture, wherein the temperature distribution can be influenced in a simple manner. Alternatively, slots of same length or point-shaped incisions can also be provided. Alternatively or additionally, a distribution or density of the incisions over the sheet steel blank of the heating element can be adapted in such that a predetermined temperature distribution is provided, in particular such that a uniform temperature distribution is provided in the region of the heating element tip or a connection region. Optionally, at least one of the slots can be connected to a partial cut in the longitudinal direction between legs. This can at least partially divert the current from a center area to an edge area and enable improved distribution of the heating power.

The first and/or second terminal electrode can be formed by extensions of the sheet steel blank. The first and/or second terminal electrode or extensions can project laterally beyond the heating element, in particular transverse to a feed direction for thermal bonding of the material layers. An advantage of this solution can be that the contact heating device can be manufactured at low cost. Furthermore, an advantage of this solution can be that the contact heating device can be mechanically fixed and inserted (laterally) between the material layers in an easy manner. The first and second terminal electrodes can be arranged laterally at the heating element and on the same side of the heating element. This enables easy lateral insertion between the upper and lower material layers.

In a further refinement, the extensions of the sheet steel blank can be configured such that the first and/or second terminal electrode is arranged in an elevated position relative to a plane in which the flat, planar sheet steel blank of the heating element is arranged; in particular, wherein the first terminal electrode and the second terminal electrode are arranged at different height levels. An elevated arrangement can ensure that a distance to the material layers is established and room is provided for a receptacle for attachment of the contact heating device. A further advantage can be a compact design. An advantage of the arrangement of the first and second terminal electrodes can be that incorrect attachment can be avoided.

The sheet steel blank of the heating element can have a thickness of between 0.1 mm and 1.5 mm, in particular between 0.5 mm and 1.0 mm, in particular between 0.7 mm and 0.9 mm. An advantage of this embodiment can be an improved material flow of the material layers to be joined, while at the same time providing sufficient mechanical stability. A good heating performance can be provided, while the heating element is sufficiently flexible but not yet too sensitive. A further advantage of this embodiment can be that the heating element can be easily inserted between the material layers to be joined. In a further refinement, the sheet steel blank comprises a uniform thickness or uniform material thickness. This can simplify manufacturing. Optionally, the heating element tip can comprise a chamfer or sloped edge. This can both smooth the mechanical transition between the material layers and increase the current density in the region of the heating element tip.

The sheet steel blank of the heating element can be mechanically flexible. In particular, the sheet steel blank of the heating element can be configured to compensate for uneven floors. Due to the flexibility of the heating element, which is configured as a flat, planar sheet steel blank, it can compensate for uneven floors. Thereby an improved seam quality can be provided. For example, the sheet steel blank of the heating element can be configured to enable bending in the longitudinal direction by 20°, in particular by 10°, in particular by 5°. In contrast to conventional rigid heating wedges, in particular heating wedges made of a solid rigid base body into which one or more heating cartridges are inserted, it suggested that the sheet steel blank of the heating element can be configured to be mechanically flexible. A further advantage of this embodiment can be that the heating element is more fault-tolerant with regard to position adjustment or attachment to an automatic joining machine. This can facilitate the use also for inexperienced users.

The sheet steel blank of the heating element can comprise a chamfer or sloped edge at the rear end or at the tip of the heating element. For example, a rolled, flat tapered end can be provided, which can also be produced cost-efficiently. This can further improve the joining of the material layers.

In addition to the sheet steel blank which forms the heating element, a further section of the sheet steel blank, in particular configured as a single piece, can be provided, wherein the further section of the sheet steel blank comprises a seam or folded edge at a rear end which is formed by folding or doubling the further section of the sheet steel blank. In other words, a further section of the sheet steel blank can be provided, which can improve mechanical stability while at the same time being inexpensive to manufacture. A further advantage can be that a fold transverse to a feed direction and on a front side in the feed direction when joining the material layers can provide a rounded front side. This can improve the sliding or gliding between material layers, as a hard or sharp edge at the tip can be avoided. This could get stuck at a material layer and possibly damage the material layer. Such a sharp edge can occur, for example, in low-cost production with punching tools.

The heating element can be adapted for an operating temperature of between 200° C. and 700° C., in particular between 300° C. and 600° C. An advantage of this solution can be that a good bond can be provided between the material layers, while at the same time the risk of temperature-induced deformation of the sheet steel blank of the heating element can be avoided or at least reduced.

The contact heating device can be configured for a current of between 50 A and 700 A, in particular between 100 A and 500 A. For example, in an application as an automatic overlap welding machine, the contact heating device can be operated at a voltage of 5 V and a current of up to 300 A. In an application for full-surface welding of bitumen sheets, for example, a voltage of up to 43 V and a current of up to 300 A can be provided.

The sheet steel blank can comprise an electrically conductive, temperature-and corrosion-resistant alloy, in particular stainless steel. For example, the sheet steel blank can be made of stainless steel 1.4301. A advantage of this embodiment can be that material layers made of materials such as PVC can also be processed. However, in contrast to the ceramic heating wedges proposed in the prior art, a flexible adaptation to the substrate is still possible.

Optionally, the contact heating device can comprise a plurality of heating elements connected between the terminal electrodes. Each of the heating elements can be configured as a directly energized, flat, planar sheet steel blank. In particular, the plurality of heating elements can comprise a common sheet steel blank. Thereby the width to be covered by the contact heating device can be increased, for example for full-surface welding of bitumen sheets. Optionally, the contact heating device can comprise several U-shaped sheet steel blanks assembled in series, which can optionally be rotated respectively by 180° relative to each other. Exemplary applications include full-surface or edge-side welding of bitumen sheets or sections.

According to a further aspect of the present disclosure, a method for determining a temperature or a temperature distribution of a contact heating device is provided comprising the steps of: measuring respective voltage drops across the respective heating elements, determining electrical, temperature-dependent partial resistances of the respective heating elements based on the measured voltage drops; and determining a temperature distribution across a width of the contact heating device based on the partial resistances of the respective heating elements.

The advantages described in detail above for the first aspect of the invention apply accordingly to the further aspects of the invention.

It is to be understood that the features mentioned above and those to be explained below can be used not only in the combination respectively indicated, but also in other combinations or separately, without departing from the scope of the present invention.

### BRIEF DESCRIPTION OF THE DRAWINGS

Exemplary embodiments of the invention are illustrated in the following drawings and are explained in more detail in the following description.

FIG. 1 shows a perspective illustration of a ground-level automatic welding machine comprising a contact heating device;

FIG. 2 shows an enlarged section of a perspective view with the contact heating device;

FIG. 3 shows a further enlarged section of a perspective view with the contact heating device from a different viewing position;

FIG. 4 shows a perspective view of a contact heating device;

FIG. 5 shows a top view of a contact heating device;

FIG. 6 shows a heat distribution of an embodiment of a contact heating device;

FIG. 7 shows a heat distribution of a further embodiment of a contact heating device;

FIG. 8 shows a top view of a further embodiment of a contact heating device;

FIG. 9 shows a further embodiment of a contact heating device, in particular for areal welding of bitumen sheets;

FIG. 10 shows a perspective illustration of an automatic welding machine with raised pressure roller;

FIG. 11 shows a perspective view of the automatic welding machine of FIG. 10 with lowered pressure roller;

FIG. 12 shows an in particular battery-operated hand-held device comprising a contact heating device;

FIG. 13 shows a top view of a contact heating device;

FIG. 14 shows a flow chart of a method for thermally induced, materially cohesive bonding of flat, flexible material layers with a contact heating device.

### DETAILED DESCRIPTION

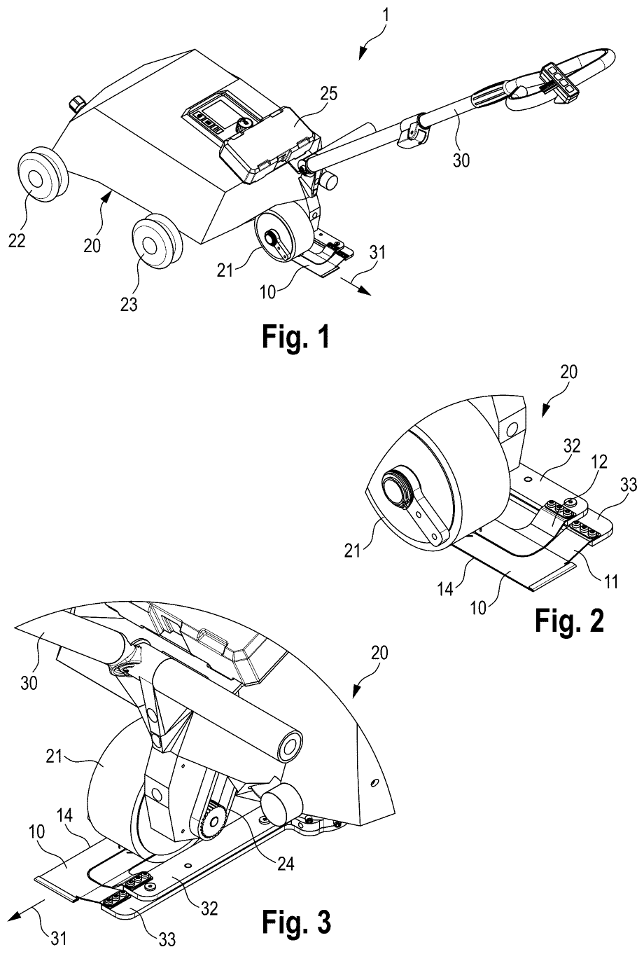

FIG. 1 shows a perspective schematic illustration of an exemplary automatic joining machine or automatic welding machine 1 for thermally induced seam (materially cohesive) bonding of weldable and/or gluable flat flexible material layers to with each other, which are configured as a material web, a material band and/or a material piece and arranged at least partially overlap. In the context of the present disclosure, an automatic joining machine is also referred to as an automatic welding machine and vice versa. The automatic welding machine 1 comprises a heating device configured as a contact heating device 10 and a chassis 20 with a guide rod 30.

FIG. 2 and FIG. 3 show enlarged sections of the automatic welding machine 1 with the contact heating device 10 of FIG. 1 from different viewing positions.

A working travel direction of the automatic welding machine 1 is designated with reference sign 31. The working travel direction 31 denotes a feed direction in which the automatic welding machine is guided along the overlapping material layers or material webs during operation for thermally induced joining of material layers with each other. The contact heating device 10 is inserted in an overlap area between an upper material layer and a lower material layer (not illustrated). As a result, the contact heating device can heat a bottom side of the upper material layer and a top side of the lower material layer or an adhesive applied to it and, in particular, at least partially plasticize or melt it.

During operation, the upper material layer is therefore arranged at least partially on a top side of the contact heating device 10. The lower material layer is arranged at least partially on a bottom side of the contact heating device 10. For thermally induced bonding, the contact heating device 10 is guided along the overlap area between the material layers. In the example shown in FIG. 1, the lower material layer is arranged, for example, on a left-hand side in the feed direction 31 and the upper material layer, which is arranged at least partially above, is arranged on a right-hand side in the feed direction 31. At least in the area in which the material layers are to be joined, the upper and lower material layers at least partially overlap.

The chassis 20 also comprises a pressure roller 21, which is configured to apply pressure to the material webs in the working direction behind the contact heating device 10. The pressure roller 21 can also be configured as a drive roller that automatically drives the automatic welding machine 1. For example, the pressure roller 21 can be driven by a belt drive 24, as illustrated in FIG. 3. A drive motor for the belt drive 24 can be arranged in a protected manner in a housing of the chassis 20. Alternatively, an optional separate drive roller can be provided. In the shown embodiment, the chassis 20 further comprises additional rollers 22, 23. It is to be understood that other embodiments of the chassis 20 and other arrangements of the contact heating device 10 on the chassis 20 are also possible. For example, instead of being arranged on a front side of the chassis 20 in the travel direction 31, the contact heating device can also be arranged on a rear side of the chassis 20 or between the front rollers 22, 23 and a following pressure roller 21. An advantage of the arrangement shown in FIG. 1 to FIG. 3 is that a user can easily check and monitor the correct positioning and guiding of the contact heating device 10 between the material layers.

The automatic welding machine 1 shown in FIGS. 1 to 3 is configured as a ground-level automatic welding machine. So-called ground-level automatic welding machines press on one side with a pressure roller 21 on the melded or fused-on overlap area of the material layers arranged on a (solid) ground. The pressure acting on the joining area therefore depends on the own weight of the automatic welding machine 1 and any additional weights 25. An advantage of the embodiment as a ground-level automatic welding machine is that no counter roller is required. This can simplify handling.

The contact heating device 10 for the thermally induced seam or materially cohesive bonding of weldable and/or gluable flat flexible material layers with each other, which are configured as a material web, a material band and/or a material piece and are arranged at least partially overlapping, comprises a first terminal electrode 11 and a second terminal electrode 12 as well as a heating element 14 connected between the terminal electrodes. The heating element 14 is configured as a directly energized, flat, planar sheet steel blank. Exemplary embodiments of the contact heating device 10 are explained in more detail with reference to the following figures.

An automatic welding machine 1 according to an aspect of the present disclosure can comprise one or more receptable or mounting arms for the contact heating device 10. In the example shown in FIG. 1 to FIG. 3, the automatic welding machine 1 comprises a first mounting arm 32 and a second mounting arm 33. The first mounting arm 32 is configured to receive the first terminal electrode 11 of the contact heating device 10. The second mounting arm 33 is configured to receive the second terminal electrode 12 of the contact heating device. Further, the first and second mounting arms 32, 33 can be configured to provide a power supply to the heating element 14 of the contact heating device 10 via the first and second terminal electrodes 11, 12. In other words, the mounting arms 31, 32 can serve both to mechanically fix and to provide power to the contact heating device 10.

As shown in FIG. 1 to FIG. 3, the mounting arms 31, 32 can be arranged and configured to hold the contact heating device 10 in front of a pressure roller 21 of the chassis 20 of the automatic welding machine 1 in the direction of travel 31. Accordingly, the contact heating device is arranged directly in front of the position at which the material layers previously heated by the contact heating device are pressed together by the pressure roller 21 and joined together. The mounting arms 32, 33 can be arranged in a plane one above the other. An electrical insulator can be provided between the mounting arms 32, 33. This arrangement can ensure a high degree of stability, while at the same time a short circuit between the current-carrying mounting arms 32, 33 can be avoided. A further advantage of this embodiment of attachment with mounting arms 32, 33 can be that a certain mechanical flexibility can be provided. For example, unevenness of the ground or of the material layers to be joined can be compensated for in a height direction.

The automatic welding machine 1 can comprise a control of the heating power that is adapted to the drive speed, which increases the heating power when the speed is increased and vice versa. Thanks to the low thermal mass of the contact heating device 10, a particularly fast regulation of the heating power and a particularly fast adjustment of the temperature can be provided. The automatic welding machine 1 can, for example, be configured to provide a heating power between 250 W and 3600 W, in particular between 500 W and 2500 W, in particular between 1000 W and 2000 W, for example 1500 W. The automatic welding machine 1 can be configured for a feed speed of between 5 m/min and 30 m/min, in particular between 10 m/min and 25 m/min, for example for a feed speed of up to 20 m/min. A width of the heating element (during operation transverse to the feed direction) can be between 10 mm and 100 mm, in particular between 15 mm and 75 mm, in particular between 20 mm and 50 mm. Exemplary widths for the heating element are 20 mm, 30 mm, 40 mm and 50 mm. An advantage of this embodiment can be that the heating element is mechanically flexible but still sufficiently stable.

In the following, exemplary embodiments of the contact heating device 10 are described.

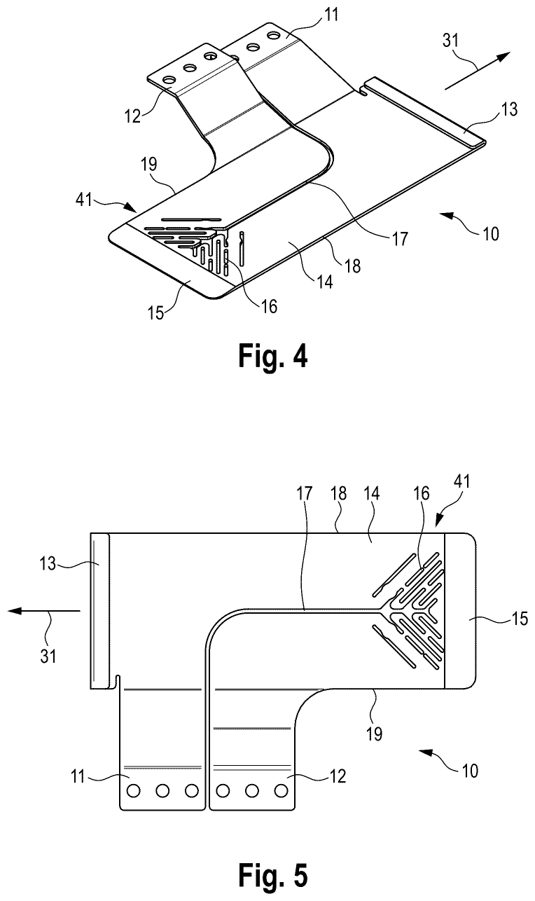

FIG. 4 and FIG. 5 show a perspective view and a top view of an embodiment of a contact heating device 10. The contact heating device 10 comprises a first terminal electrode 11 and a second terminal electrode 12 as well as a heating element 14 connected between the terminal electrodes 11, 121. The heating element 14 is configured as a directly energized, flat, planar sheet steel blank.

The sheet steel blank of the heating element is mechanically flexible and can, in particular, be configured to compensate for unevenness in the ground. The sheet steel blank of the heating element has a thickness between 0.1 mm and 1.5 mm, in particular between 0.5 mm and 1.0 mm, in particular between 0.7 mm and 0.9 mm.

As shown in FIG. 4 and FIG. 5, the sheet steel blank of the heating element 14 can comprise at least one partial cut 17 in the longitudinal direction. In particular, the sheet steel blank of the heating element comprises a planar U-shaped geometry. Hereby, the sheet steel blank of the heating element 14 can comprise the following: a first flat, planar leg 18, which is connected to the first terminal electrode 11; a second flat, planar leg 19, which is connected to the second terminal electrode 12; wherein the first leg 18 and the second leg 19 are arranged flat adjacent to each other in the same plane. However, it is also possible that the first leg 18 and the second leg 19 are arranged flat on top of each other. At a heating element tip, the sheet steel blank comprises a connection region 41 which connects the first leg 18 and the second leg 19 to one another. In other words, a current provided via the first terminal electrode 11 and the second terminal electrode 12 is conducted via the first leg 18 and the second leg 19 into the connection region 41 of the heating element 14. The heating element can be considered to be that part of the sheet steel blank which is configured to provide at least 70%, in particular at least 80%, in particular at least 90% of a heating power of the contact heating device. Depending on the embodiment, sections of the sheet steel blank that establish a connection to the connection contacts 11, 12, on the other hand, only contribute a smaller proportion to the heating power.

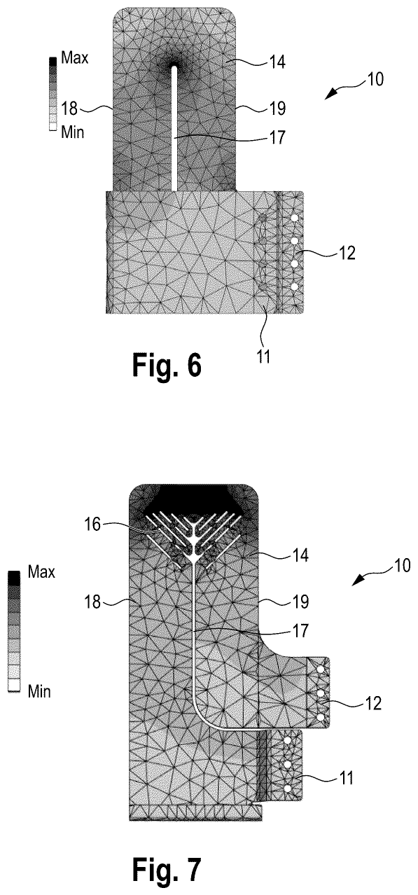

The contact heating device 10 with the heating element 14 can, as described above, be configured to provide an increased temperature in the connection area 41 compared to the legs 18, 19. FIG. 6 and FIG. 7 show exemplary temperature distributions of different embodiments. As can be seen from FIG. 6, there is an increased temperature in the connection region 41 at a transition from the legs. However, the temperature distribution can preferably be influenced in that the connection region 41 comprises structurings or structures 16 which are configured to further modify the temperature distribution. In particular, the connection region 41 can comprise structurings 16 in the form of incisions or openings which are configured to locally reduce the energized cross-section or cross-section with current flow in comparison to the unstructured cross-section (see FIG. 6) and to thus locally increase the heating power (see FIG. 7). The incisions can, for example, be formed as punched or laser-cut incisions in the sheet steel blank.

FIG. 7 shows an exemplary heat distribution corresponding to the embodiment in FIG. 4 and FIG. 5. The structuring 16 changes the current distribution and thus also the heating power such that a current density in the connection region, which is arranged at a rear edge in relation to the direction of travel 31, is on the one hand increased and thus higher temperatures are provided and on the other hand is also distributed more evenly over a width of the heating element 14 of the contact heating device.

As shown in FIG. 4, FIG. 5 and FIG. 7, the incisions can be configured as elongated incisions, in particular as elongated incisions at an angle to the rear edge of the heating element tip, in particular at an angle between 20° and 80°, in particular between 30° and 60°.

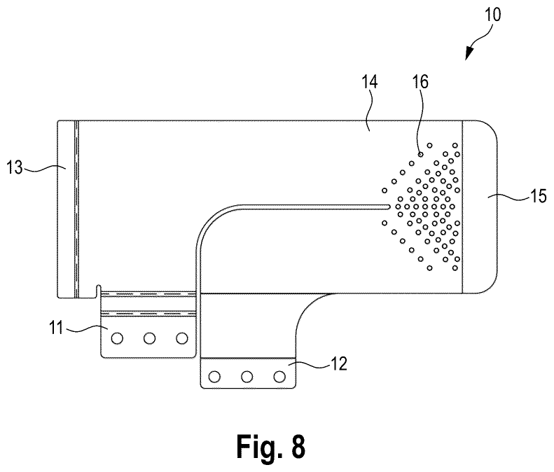

It is to be understood that the structuring in the form of incisions (or recesses or openings), which are configured to locally reduce the energized cross-section in comparison to the unstructured cross-section, and thus to locally increase the heating power, are not limited to elongated incisions, but can also be provided in other shapes. FIG. 8, for example, shows a further embodiment of a contact heating device 10, wherein incisions in the form of round openings are provided, wherein the arrangement and density of the incisions is configured to provide a predetermined temperature distribution.

As shown in FIG. 4, FIG. 5, FIG. 7 and FIG. 8, the incisions can be arranged symmetrically, at least in sections. In particular, the incisions can be arranged in a fanned-out tree shaped matter. Thereby the current can also be distributed to the outer regions of the sheet steel blank. An advantage of this embodiment is a more even temperature distribution across the width of the heating element 10.

In the embodiment shown in FIG. 4, the first and/or second terminal electrodes 11, 12 are formed by extensions of the sheet steel blank. The extensions project laterally beyond the heating element 14, in particular transversely to a feed or travel direction 31. The first and second terminal electrodes 11, 12 are arranged laterally at the heating element and on the same side of the heating element. In particular, the extensions of the sheet steel blank can be configured such that the first and/or second terminal electrodes 11, 12 are arranged in an elevated position relative to a plane in which the flat, planar sheet steel blank of the heating element 14 is arranged; in particular wherein the first terminal electrode 11 and the second terminal electrode 12 are arranged at different height levels. This can provide an advantageous attachment, for example to a first and second mounting arm 32, 33 as shown in FIG. 1 to FIG. 3. This applies correspondingly to the embodiment shown in FIG. 8.

With regard to the terminal electrodes 11, 12, a further possible embodiment is shown in FIG. 6, wherein the first and second terminal electrodes are also formed by extensions of the sheet steel blank and at least partially overlap or are arranged one above the other. The area of the sheet steel blank that forms the heating element is also configured as a directly energized, flat, planar sheet steel blank. Only the sections of the terminal electrodes that do not contribute significantly to the heating power are located in sections outside a flat plane of the heating element.

Optionally, a chamfer or sloped edge 15 can be provided at the tip or the rear edge of the contact heating device 10 in the working travel direction 31, as for example shown in FIG. 5 and FIG. 8. This allows the contact heating device 10 comprising the heating element 14 to be positioned very close to the pressure roller 21, as shown in FIG. 1 to FIG. 3. A chamfer or sloped edge 15 can be provided on the top or bottom side or even a double chamfer or sloped edge on the top and bottom side.

A seam 13 can be provided at a front edge of the contact heating device 10 in the working travel direction 31. The seam 13 can, for example, be formed by bending or doubling a section of the sheet steel blank. As a result, the wedge does not stick at layer transitions. Furthermore, a mechanical stability can be improved, while flexibility is still maintained, in particular in the working travel direction.

In other words, according to one aspect of the present disclosure, a contact heating device 10 can consist of a flat sheet steel blank, typically rectangular in shape, made of an electrically conductive, temperature and corrosion resistant alloy such as for example stainless steel 1.4301. The use of a flat sheet steel leads to a high mechanical flexibility of the contact heating device 10, which has a positive effect on the thermal contact between the contact heating device 10 and the welding material, which is essential for good welding quality. By the flexibility, an uneven surface or slight mis-adjustments or misalignments or manipulations can be compensated for. In the longitudinal direction, the sheet steel blank can comprise a partial cut 17, resulting in a U-shaped geometry, as shown in FIG. 4. Electrical terminals 11, 12 are provided at both ends of the “U” to supply electrical current to the sheet steel. At the same time, these also serve as a mechanical mount. The electrical power is thereby converted into thermal power directly in the sheet steel. The sheet steel blank thus serves as a heating conductor.

The U-shape on the one hand provides the advantage that the ratio between the length and width of the heating conductor is increased for the same area, and thus also the electrical resistance, which in turn simplifies the electrical supply. The higher the resistance, the lower the current required to achieve a certain heating power. Among other things, this can reduce the cable cross-section of the feed and thus save costs. On the other hand, the U-shape simplifies the electrical and mechanical connection to a welding device, as shown in FIG. 1, without disturbing the welding process.

Applying current to the U-shaped heating conductor causes it to heat up. For welding applications, it is advantageous if the heating conductor is heated as evenly as possible across its width. However, in the area of the redirection, also referred to as the connection region 14, the current density would be greater at the inner radius than at the outer radius, as the current path would be shorter at the inner radius and the local resistance would therefore be smaller (“the current takes the path of the least resistance”). This would lead to greater heating of the heating conductor at the inner radius than at the outer radius, as illustrated in FIG. 6. In order to counteract this, the contact heating device 10 according to an aspect of the present disclosure comprises structuring 16 in the area of the redirection or in the connection region 14 of the legs 18, 19 at the inner radius, for example in the form of incisions, as shown in FIG. 4 and FIG. 5. These narrow the conductor cross-section at the inner radius and thus increase the local electrical resistance, so that the current density in the area of the redirection is distributed more evenly over the width of the redirection and thus a more even heating is achieved over the width in this area, as illustrated in FIG. 7. In addition, with the structuring 16, the distribution of the heating in the longitudinal direction can also be improved, in that the greatest heating occurs in the region of the rear heating element tip, as illustrated in FIG. 7. This is advantageous for good weld seam quality, as the contact pressure is applied directly in this area or directly subsequent to it, as illustrated in FIG. 1 to FIG. 3.

The structuring 16 in the form of branches has the advantage that the structured region is still traversed by the current, albeit to a lesser extent, and thus also heated, which favors uniform distribution, as shown in FIG. 7.

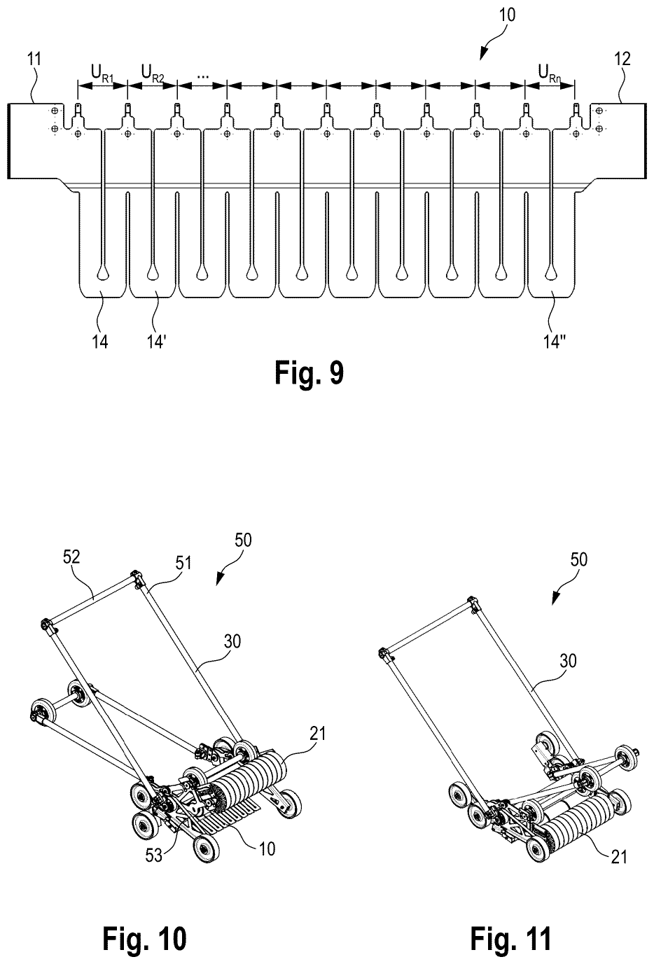

FIG. 9 shows a further embodiment of a contact heating device 10, in particular for the (fully) areal welding of bitumen sheets. Herein, two lower material layers can for example be provided that are arranged next to each other, wherein a contact area or any gap between the lower material layers can be covered by an upper layer of material overlapping the lower material layers. Thereby a seal between the two material lower layers can efficiently be formed.

As shown in FIG. 9, the contact heating device 1 can comprise a plurality of heating elements 14 connected between the terminal electrodes 11, 12, wherein each of the heating elements is configured as a directly energized, flat, planar sheet steel blank. The structuring in the region of the heating element tip is less important in this case, as on the one hand bitumen sheets are more tolerant, among other things due to the usually greater material thickness, and on the other hand the arrangement of several heating elements 14, 14′, . . . 14″ next to each other also achieves a homogenizing effect, at least over the width of the weld seam or the entire contact heating device. However, the use of structuring can further improve the temperature distribution.

FIG. 10 shows a perspective view of an automatic welding machine 50 comprising a contact heating device 10, as illustrated in FIG. 9, with a raised pressure roller 21. FIG. 11 shows a perspective view of the automatic welding machine 50 from FIG. 10 with a lowered pressure roller 21. The automatic welding machine 50 can configured as a movable automatic welding machine 50 for (full-surface) welding of a bitumen sheet onto an already laid-out bitumen sheet. The automatic welding machine 50 can comprise a frame 51, on the top side of which a handle 52 is arranged and which has a mount 53 for the contact heating device 10 and a lowerable pressure roller 21 on the bottom side.

The automatic welding machine 50 can, for example, be configured to provide a heating power of between 2 KW and 20 KW, in particular between 5 W and 15 KW, for example of 10 KW. The automatic welding machine 50 can be configured for a feed speed of between 0.5 m/min and 30 m/min, in particular between 1 m/min and 10 m/min, in particular between 1 m/min and 5 m/min, for example for a feed speed of 1.5or 3 m/min. A width of the heating element (during operation transverse to the feed direction) can be between 10 mm and 1.5 m, in particular between 20 cm and 1.5 m, in particular between 0.5 m and 1.2 m, for example for a width of 1 m or 1.2 m. The several heating elements 14, 14′ . . . 14″ arranged next to each other, which are each configured as directly energized, flat, planar sheet steel blanks, allow cost-effective production and flexible adaptation to uneven surfaces, such as those that occur when sealing roofs. In addition, with such an automatic welding machine, an open flame, as is usually used when laying bitumen, becomes obsolete, which increases safety.

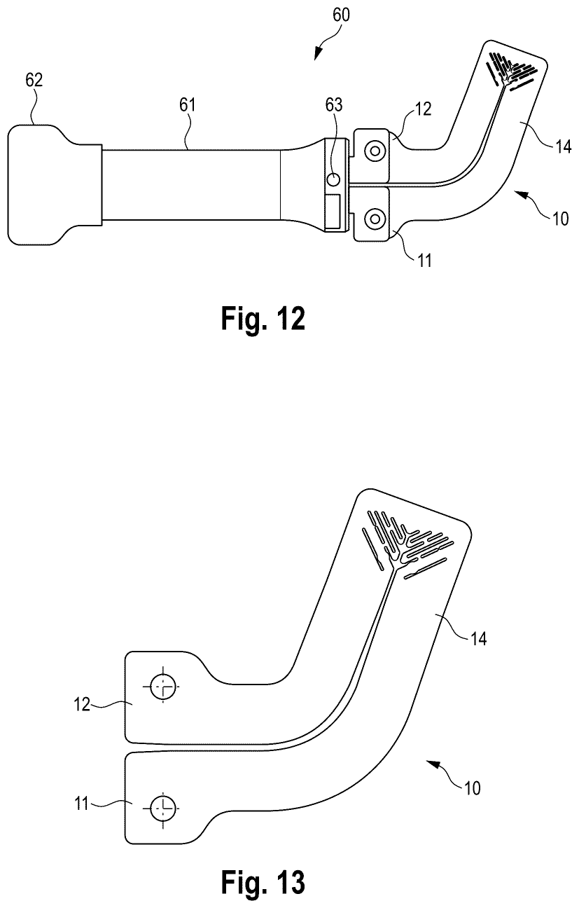

FIG. 12 shows a hand-held device 60 with a contact heating device 10. FIG. 13 shows a top view of the contact heating device 10 for the hand-held device of FIG. 12. The hand-held device 60 comprises a housing body 61, which can also serve as a handle. In an embodiment as a battery-powered hand-held device 60, the hand-held device comprises a battery 62. The battery 62 can, for example, be integrated into the housing body 61 or can also be configured as a replacement battery, for example attached to or integrated into the housing body 61. The handheld device 60 can further comprise HMI or operating elements 63. With the operating elements 63, for example, a desired temperature or heating power can be set.

The contact heating device 10 can be attached to the housing 61 via a first terminal electrode 11 and a second terminal electrode 12 and can also be supplied with power at the same time. A heating element 14 is connected between the terminal electrodes 11, 12. The heating element 14 is configured as a directly energized, flat, planar sheet steel blank. The heating element can comprise one or more further features as described in the context of the present disclosure, for example structuring to provide a desired temperature distribution.

The proposed hand-held device 60 can, for example, be used for detail work or repairs to material webs to be joined. For example, for bitumen sealing or waterproofing, sections of bitumen webs are welded together manually. The proposed hand-held device can also be advantageous in places that are difficult to access. Optionally, the contact heating device 10 as shown in FIG. 12 and FIG. 13 can comprise a deflection or be configured as an angled contact heating device 10. This facilitates lateral insertion and work along a joining area between the material layers to be joined. In addition, with such a hand-held device, an open flame, as is usually used when laying bitumen, becomes obsolete, which increases safety.

The hand-held device 60 can, for example, be configured to provide a heating power between 100 W and 3600 W, in particular between 250 W and 2500 W, in particular between 1000 W and 2000 W, for example 1500 W. The hand-held device 1 can be configured for welding speeds between 5 m/min and 30 m/min, in particular between 10 m/min and 25 m/min, for example for a feed speed of up to 20 m/min. A width of the heating element (transverse to the tip) can be between 10 mm and 100 mm, in particular between 15 mm and 75 mm, in particular between 20 mm and 50 mm. Exemplary widths for the heating element are 20 mm, 30 mm, 40 mm and 50 mm. An advantage of this embodiment can be that the heating element is mechanically flexible but still sufficiently stable.

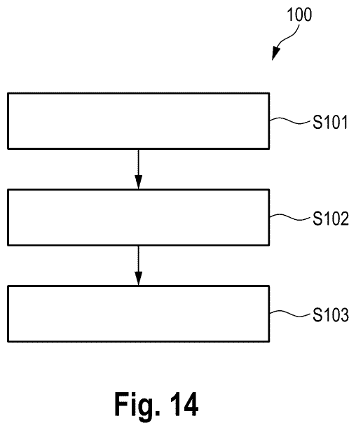

FIG. 14 shows a flow chart of a method 100 for the thermally induced, seam bonding of flat, flexible material layers with a contact heating device. In particular, this can be a method which can be used in conjunction with a contact heating device 10 comprising a plurality of heating elements 14, 14′, . . . 14″, as exemplarily shown in FIG. 9.

In a first step S101, the respective voltage drops U_{R1}, U_{R2}, . . . . U_{RN} across the respective heating elements 14, 14′, . . . 14″ are measured. In a subsequent step S102, electrical, temperature-dependent partial resistances of the respective heating elements 14, 14′, . . . 14″ are determined based on the measured voltage drops U_{R1}, U_{R2}, . . . . U_{RN}. In step S103, a temperature distribution over a width of the contact heating device 10 is determined based on the partial resistances of the respective heating elements 14, 14′, . . . 14″. The proposed method allows monitoring a welding temperature during thermally induced, adhesive bonding of flat, flexible material layers. An advantage of this embodiment can be improved quality assurance and documentation.

If, for example, one of the heating elements is no longer in contact with or is only in poor contact with the material web, for example due to wrinkling of the material web, the respective heating element heats up more, as the heat is no longer discharged via the material of the material layer. The resistance of the heating element increases and thus also the partial voltage in comparison with the further heating elements. With the proposed method, this can be visualized and monitored. Thereby process reliability can be improved when thermally joining material layers.

In conclusion, the solutions proposed herein can be used to provide an improved contact heating device, an improved automatic joining machine and/or an improved hand-held device for thermally induced seam bonding of weldable and/or gluable flat flexible material layers with each other, which are configured as a material web, a material band and/or a material piece and arranged at least partially overlapping. This can improve handling and also make handling easier for less experienced users. Furthermore, the proposed solution can contribute to further improve operational safety, efficiency and/or welding speed.

It is to be understood that the foregoing description is of one or more embodiments of the invention. The invention is not limited to the particular embodiment(s) disclosed herein, but rather is defined solely by the claims below. Furthermore, the statements contained in the foregoing description relate to the disclosed embodiment(s) and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation. In addition, the term “and/or” is to be construed as an inclusive OR. Therefore, for example, the phrase “A, B, and/or C” is to be interpreted as covering all of the following: “A”; “B”; “C”; “A and B”; “A and C”; “B and C”; and “A, B, and C.”

1. A contact heating device for thermally induced seam bonding of weldable and/or gluable flat flexible material layers with each other, which are configured as a material web, a material band and/or a material piece and are arranged at least partially overlapping, the contact heating device comprising:
a first terminal electrode and a second terminal electrode; and
a heating element connected between the terminal electrodes;
wherein the heating element is configured as a directly energized, flat, planar sheet steel blank.

2. A contact heating device according to claim 1, wherein the sheet steel blank of the heating element comprises at least one partial cut in longitudinal direction, in particular and/or wherein the sheet steel blank of the heating element comprises a planar U-shaped geometry.

3. The contact heating device according to claim 1, wherein the sheet steel blank of the heating element comprises the following:
a first flat, planar leg, which is connected to the first terminal electrode;
a second flat, planar leg, which is connected to the second terminal electrode;
wherein the first leg and the second leg are arranged flat on top of each other or adjacent to each other in the same plane; and
wherein the sheet steel blank of the heating element comprises a connection region at a heating element tip, which connects the first leg and the second leg to one another.

4. The contact heating device according to claim 3, wherein the heating element is configured to provide an increased temperature in the connection region compared to the legs.

5. The contact heating device according to claim 3, wherein the connection region comprises structurings in the form of incisions, which are configured to locally reduce the energized cross-section in comparison to an unstructured cross-section, and thus to locally increase the heating power.

6. The contact heating device according to claim 5, wherein the incisions are arranged symmetrically at least in sections.

7. The contact heating device according to claim 1, wherein the first and/or second terminal electrodes are formed by extensions of the sheet steel blank and project laterally beyond the heating element transversely to a feed direction for thermally bonding the material layers.

8. The contact heating device according to claim 1, wherein the sheet steel blank of the heating element has a thickness of at least one of between 0.1 mm and 1.5 mm, in particular and/or between 0.5 mm and 1.0 mm, in particular and/or between 0.7 mm and 0.9 mm.

9. The contact heating device according to claim 1, wherein the sheet steel blank of the heating element is mechanically flexible; so as to compensate for uneven floors.

10. The contact heating device according to claim 1, wherein, in addition to the sheet steel blank which forms the heating element, a further section of the sheet steel blank is provided, wherein the further section of the sheet steel blank comprises a seam at the rear end, which is formed by folding or doubling of the further section of the sheet steel blank.

11. The contact heating device according to claim 1, wherein the sheet steel blank comprises an electrically conductive, temperature-and corrosion-resistant alloy, in particular and/or stainless steel.

12. The contact heating device according to claim 1, wherein the contact heating device comprises a plurality of heating elements connected between the terminal electrodes, wherein each of the heating elements is configured as a directly energized, flat, planar sheet steel blank.

13. An automatic joining machine for thermally induced seam bonding of flat, flexible material layers, the automatic joining machine comprising a contact heating device according to claim 1.

14. A hand-held , in particular a battery-powered hand-held device, for thermally induced seam bonding of flat, flexible material layers, the hand-held device comprising a contact heating device according to claim 1.

15. A method for thermally induced seam bonding of flat, flexible material layers with a contact heating device according to claim 12, comprising the steps of:
measuring respective voltage drops across the respective heating elements,
determining electrical, temperature-dependent partial resistances of the respective heating elements based on the measured voltage drops; and
determining a temperature distribution across a width of the contact heating device based on the partial resistances of the respective heating elements.

16. The contact heating device according to claim 5, wherein the incisions are configured as elongated incisions arranged at an angle to the rear edge of the heating element tip at at least one of an angle between 20° and 80° or at an angle between 30° and 60°.

17. The contact heating device according to claim 6, wherein the incisions are arranged in a fanned out, tree shaped manner.

18. The contact heating device according to claim 5, a distribution or density of the incisions over the sheet steel blank of the heating element is adapted to provide a predetermined temperature distribution over the sheet steel blank.

19. The hand-held device according to claim 14, wherein the hand-held device is a battery-powered hand-held device.
